(19) United States
(12) Patent Application Publication
(10) Pub. No.: US 2011/0086207 A1
(43) Pub. Date: Apr. 14, 2011

(54) DIAMOND APPARATUS AND METHOD OF MANUFACTURE

(76) Inventors: Heidi B. Martin, Euclid, OH (US); Christain A. Zorman, Euclid, OH (US); Allison E. Hess, Cleveland Heights, OH (US); David M. Sabens, Cleveland Heights, OH (US); Clifford C. Hayman, Madison, OH (US); Jeffrey M. Halpern, Cleveland Heights, OH (US)

(21) Appl. No.: 12/796,659

(22) Filed: Jun. 8, 2010

Related U.S. Application Data
(60) Provisional application No. 61/185,147, filed on Jun. 8, 2009.
(60) Provisional application No. 61/185,155, filed on Jun. 8, 2009.
(60) Provisional application No. 61/185,572, filed on Jun. 9, 2009.

(51) Int. Cl. B05D 3/06; B32B 3/10

(52) U.S. Cl. 428/195.1; 427/510

(57) ABSTRACT

A method of manufacturing a diamond apparatus includes forming an insulating layer on a surface of a substrate, forming a masking layer on a surface of the insulating layer, and forming a photoresist layer on a surface of the masking layer. A portion of the photoresist layer is cross-linked through exposure to light, leaving a portion of the photoresist layer non-cross-linked. The non-cross-linked portion of the photoresist layer is removed from the masking layer, thus exposing a portion of the masking layer. The method further includes removing the exposed masking layer portion. Any remaining portion of the cross-linked photoresist layer is also removed, resulting in the formation of a patterned masking layer extending from the insulation layer. Diamond material is seeded onto the patterned masking layer and an exposed portion of the insulation layer. The masking layer is removed, resulting in a patterned diamond apparatus extending from the insulating layer

### CROSS-REFERENCE TO RELATED APPLICATIONS

This application claims the priority of U.S. Provisional Patent Application Ser. No. 61/185,147 filed Jun. 8, 2009, titled “PATTERNED DIAMOND APPARATUS AND METHOD OF MANUFACTURE;” U.S. Provisional Patent Application Ser. No. 61/185,155 filed Jun. 8, 2009, titled “PATTERNED DIAMOND APPARATUS AND METHOD OF MANUFACTURE;” and U.S. Provisional Patent Application Ser. No. 61/185,572 filed Jun. 9, 2009, titled “DIAMOND APPARATUS WITH DUCTILE SUBSTRATE AND METHODS OF MANUFACTURE;” all of which are hereby incorporated by reference herein in their entirety.

### TECHNICAL FIELD

The disclosed apparatuses and methods relate generally to the field of devices formed from diamond material and more particularly to diamond devices formed on substrates.

### BACKGROUND

Apparatuses and devices formed from diamond material such as bulk crystal diamond and thin diamond films have been used for various applications. The application of such apparatuses and devices is generally attributable to the favorable properties of diamond. Because of such favorable properties, apparatuses and devices formed from diamond material may be used in electronic circuitry, sensors, implantable biological devices, and the like.

### SUMMARY

In one example, a method of manufacturing a patterned diamond apparatus includes forming an insulating layer on a surface of a substrate. The method further includes forming a masking layer on a surface of the insulating layer and forming a photoresist layer on a surface of the masking layer. A portion of the photoresist layer is cross-linked through exposure to light, leaving a portion of the photoresist layer non-cross-linked. The non-cross-linked portion of the photoresist layer is removed from the masking layer by a chemical bath, thus exposing a portion of the masking layer under the non-cross-linked photoresist portion. The method further includes removing the exposed masking layer portion with an etchant. Any remaining portion of the cross-linked photoresist layer is also removed, resulting in the formation of a patterned masking layer extending from the insulation layer. Diamond material is seeded onto the patterned masking layer and an exposed portion of the insulation layer. The masking layer is removed through exposure to an etchant, resulting in a patterned diamond apparatus extending from the insulating layer

In another example, a method of manufacturing a flexible patterned diamond apparatus includes forming a diamond apparatus on a generally rigid substrate and transferring the diamond apparatus to a generally flexible substrate. The method includes forming an insulating layer on a surface of a generally rigid substrate. The method further includes forming a masking layer on a surface of the insulating layer and forming a photoresist layer on a surface of the masking layer. A portion of the photoresist layer is cross-linked through exposure to light, leaving a portion of the photoresist layer non-cross-linked. The non-cross-linked portion of the photoresist layer is removed from the masking layer by a chemical bath, thus exposing a portion of the masking layer under the non-cross-linked photoresist portion. The method further includes removing the exposed masking layer portion with an etchant. Any remaining portion of the cross-linked photoresist layer is also removed, resulting in the formation of a patterned masking layer extending from the insulation layer. Diamond material is seeded onto the patterned masking layer and an exposed portion of the insulation layer. The masking layer is removed through exposure to an etchant, resulting in a patterned diamond apparatus extending from the insulating layer, which is secured to the generally rigid substrate. Patterned metal connections are formed in electrical communication with the patterned diamond apparatus. A flexible substrate is formed about the patterned diamond apparatus, and the flexible substrate and patterned diamond apparatus are released from the rigid substrate to form a flexible patterned diamond apparatus.

A patterned diamond apparatus includes a substrate, an insulation layer and at least two features arranged in a pattern. The insulation layer is coupled to a surface of the substrate and each of the at least two features are coupled to a surface of the insulating layer. Each of the at least two features is comprised of diamond material and the boundaries of each feature is highly resolved.

A flexible patterned diamond apparatus includes a flexible substrate, a network of connections, and a patterned diamond apparatus. The network of connections and patterned diamond apparatus are secured to the flexible substrate, and the network of connections is in electrical and thermal communication with the patterned diamond apparatus.

### BRIEF DESCRIPTION OF THE DRAWINGS

It is believed that certain examples will be better understood from the following description taken in combination with the accompanying drawings in which:

FIG. 1 is a schematic cross-sectional view of a partially manufactured patterned diamond apparatus;

FIG. 2 is a schematic cross-sectional view of a partially manufactured patterned diamond apparatus;

FIG. 3 is a schematic cross-sectional view of a partially manufactured patterned diamond apparatus;

FIG. 4 is a schematic cross-sectional view of a partially manufactured patterned diamond apparatus;

FIG. 5 is a schematic cross-sectional view of a partially manufactured patterned diamond apparatus;

FIG. 6 is a schematic cross-sectional view of a partially manufactured patterned diamond apparatus;

FIG. 7 is a schematic cross-sectional view of a partially manufactured patterned diamond apparatus;

FIG. 8 is a schematic cross-sectional view of a patterned diamond apparatus;

FIG. 9 is a schematic cross-sectional view of a patterned diamond apparatus;

FIG. 10A is a color photograph of a partially manufactured patterned diamond apparatus;

FIG. 10B is a color photograph of a partially manufactured patterned diamond apparatus;

FIG. 11 is a color photograph of a patterned diamond apparatus;

FIG. 12 is a color photograph of a patterned diamond apparatus;

FIG. 13 is a color photograph of a patterned diamond apparatus;

FIG. 14 is a color photograph of a patterned diamond apparatus;

FIG. 15 is three-dimensional color confocal images of a patterned diamond apparatus;

FIG. 16 is a schematic cross-sectional view of a partially manufactured flexible patterned diamond apparatus;

FIG. 17 is a schematic cross-sectional view of a partially manufactured flexible patterned diamond apparatus;

FIG. 18 is a schematic cross-sectional view of a partially manufactured flexible patterned diamond apparatus;

FIG. 19 is a schematic cross-sectional view of a partially manufactured flexible patterned diamond apparatus;

FIG. 20 is a schematic cross-sectional view of a partially manufactured flexible patterned diamond apparatus;

FIG. 21 is a schematic cross-sectional view of a partially manufactured flexible patterned diamond apparatus;

FIG. 22 is a schematic cross-sectional view of a partially manufactured flexible patterned diamond apparatus;

FIG. 23 is a schematic cross-sectional view of a partially manufactured flexible patterned diamond apparatus;

FIG. 24 is a schematic cross-sectional view of a released flexible patterned diamond apparatus;

FIG. 25 is a schematic cross-sectional view of a flexible patterned diamond apparatus;

FIG. 26 is a color photograph of a flexible patterned diamond apparatus;

FIG. 27 is a color photograph of a flexible patterned diamond apparatus;

FIG. 28 is a color photograph of a flexible patterned diamond apparatus;

FIG. 29 is a color photograph of a flexible patterned diamond apparatus;

FIG. 30 is a color photograph of a flexible patterned diamond apparatus;

FIG. 31 is a schematic view of a diamond apparatus with a flexible substrate;

FIG. 32 is a schematic view of a diamond apparatus with a flexible substrate;

FIG. 33 is a schematic illustration of a method for growing diamond on a substrate;

FIG. 34 is a schematic view of a diamond apparatus with a flexible substrate;

FIG. 35 is a photograph of a fracture surface of a flexible substrate;

FIG. 36 is a schematic illustration of deflection testing of a flexible substrate; and

FIG. 37 is a schematic illustration of a method for growing diamond on a substrate.

### DETAILED DESCRIPTION

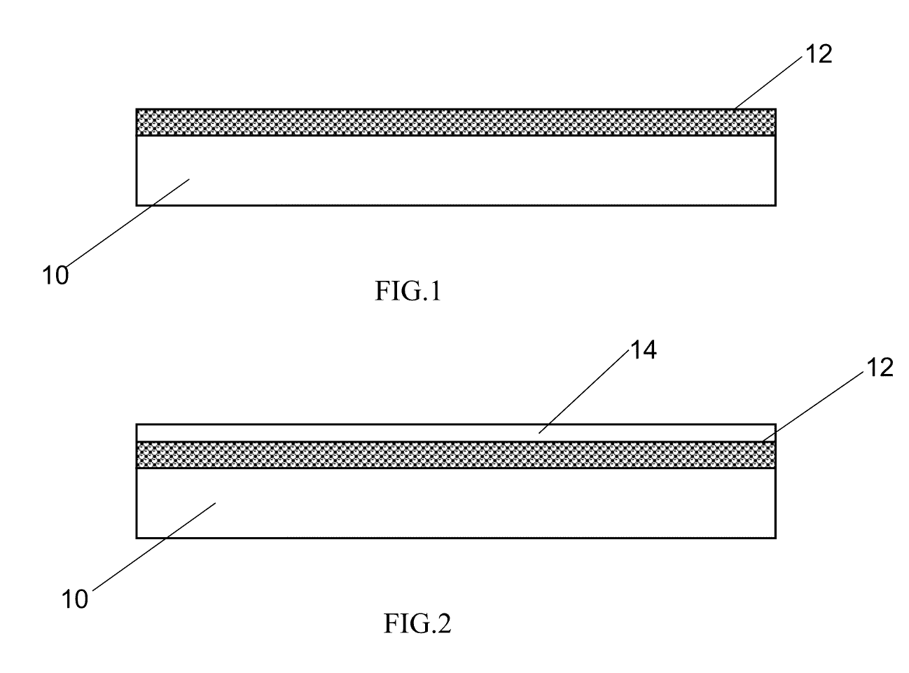

The apparatus and methods disclosed and described in this document are described in detail with the views and examples of the included figures. Unless otherwise specified, like numbers in figures indicate references to the same or corresponding elements throughout the views of the figures. Those of ordinary skill in this art will recognize that modifications to disclosed and described components, elements, methods, materials, etc. can be made and may be desired for a specific application. In this disclosure, any identification of specific shapes, materials, techniques, and the like are either related to a specific example presented or are merely a general description of such a shape, material, technique, etc. Identifications of specific details are not intended to be and should not be construed as mandatory or limiting unless specifically designated as such. Selected examples of diamond apparatus and methods of manufacture are hereinafter disclosed and described in detail with reference made to FIGS. 1 through 37.

The apparatus and methods disclosed and described herein are generally directed to diamond apparatus and methods of manufacturing such apparatus. Such an apparatus can be for example a patterned diamond apparatus. In other examples, an apparatus can be non-patterned. A patterned diamond apparatus can comprise highly-resolved features within the patterned diamond apparatus secured to a flexible or rigid substrate. In one example, highly-resolved features are comprised of diamond material where each feature has well-defined boundaries and each feature or a group of features form a functional component. Such well-defined boundaries can make a feature distinct from adjacent features so that each feature can independently function as an electrical sensor, electrochemical sensor, electromechanical sensor, electrode, or other such apparatus or device. In addition, highly-resolved features may be arranged such that two or more features cooperatively interact to comprise a sensor, apparatus, electrode, or device.

Methods disclosed herein may be applied to manufacture fully functional diamond apparatuses directly or indirectly into systems, including into systems that are typically incompatible with diamond growth processes. In one example, a patterned diamond apparatus can be flexible. A patterned diamond network can be grown, deposited, or otherwise formed on a generally rigid substrate and subsequently transferred, released, or otherwise removed from the rigid substrate and form a flexible patterned diamond apparatus. Diamond is a viable and valuable material for many apparatus, devices, and systems such as, for example, electrical circuitry, electrochemical devices, electromechanical devices, implantable biological devices, and the like. Diamond material typically includes valuable properties such as, for example, low and stable background current, wide potential window, and an inert nature.

Patterned diamond apparatus may be manufactured by seeding, growing, depositing, or otherwise coupling diamond material to substrates. Methods for such coupling of diamond material to a substrate include, but are not limited to, chemical vapor deposition. As will be further described herein, chemical vapor deposition may include a number of methods and provide for multiple processes of nucleation and growth of diamond material on substrates. When the coupling of diamond material to a substrate results in the diamond material being arranged in a pattern, the resulting apparatus or device can be utilized for a wide variety of applications. Such substrates can be either rigid or flexible (i.e., ductile). From the patterned diamond apparatus, a flexible diamond apparatus may be manufactured by additional processes that rearrange, reconfigure, transfer, or remove the patterned diamond apparatus from the rigid substrate to a flexible substrate. As will be discussed herein, the patterned diamond apparatus can be arranged on or within flexible materials to form a flexible patterned diamond apparatus.

Throughout this disclosure, examples of methods of manufacturing flexible patterned diamond apparatus will be described and disclosed. Such methods include two-stage processes of forming or manufacturing a flexible patterned diamond apparatus. A first stage of forming a flexible patterned diamond apparatus is to form a patterned diamond apparatus on a generally rigid substrate. The resulting configuration of this stage will generally be referred to as a “patterned diamond apparatus.” Such an apparatus has functionality and utility and can be used as an electrical sensor, electrochemical sensor, electromechanical sensor, electrode, or other such apparatus or device. A second stage includes forming a flexible substrate on or about a patterned diamond apparatus. The resulting configuration of this stage will generally be referred to as a “flexible patterned diamond apparatus” to distinguish it from the patterned diamond apparatus formed on a rigid substrate. A flexible patterned diamond apparatus also has functionality and utility and can be used as an electrical sensor, electrochemical sensor, electromechanical sensor, electrode, or other such apparatus or device. The flexible property of such an apparatus provides for increased functionality as a biological sensor or other such applications that benefit from a device that can flex, bend, twist, and otherwise deflect.

In one example, patterned diamond apparatus may be manufactured by depositing or growing diamond material on a substrate comprising insulating material. One such insulating material is silicon dioxide. It will be readily understood by one of ordinary skill in the art that silicon dioxide is merely an example of insulating material and other materials may be used. For example, materials such as alumina may provide a robust platform on which to design electronic circuitry and other such apparatus and devices.

The use of an insulating material such as silicon dioxide or alumina as a substrate material for the manufacture of diamond apparatus allows for post-manufacture integration of such apparatus into systems such as circuitry, implantable biological devices, and other systems that are otherwise incompatible with diamond apparatus due to the harsh conditions required to grow or deposit diamond material in manufacturing a device. Examples of such systems include systems that are flexible. Flexible diamond devices can be suitable for applications such as, for example, electrodes suitable for neural electrophysiology or neural electrochemistry measurements. Diamond properties include high chemical inertness, high resistance to fouling, good biocompatibility, wide water window, and low background current of diamond. Such properties provide for electrodes that are well suited for neural recording, stimulation, chemical detection, etc.

Electrodes used for biological applications, such as peripheral nerve cuff electrodes can benefit from being flexible. Flexibility allows for an electrode to conform to nerve tissue and to generally match the mechanics of biological tissue. However, flexible material generally does not withstand the harsh environment required to form diamond apparatus, particularly elevated temperature. Methods for forming a patterned diamond apparatus on generally rigid substrates that can withstand the diamond-forming environment and transferring the apparatus from such a substrate to an arrangement that provides for flexibility are described and disclosed herein.

As will be further described and disclosed herein, examples of methods for manufacturing patterned diamond apparatus with highly-resolved features on an insulating material layer of a generally rigid substrate include combinations of methods and techniques for masking a substrate, seeding diamond material, and growing or depositing diamond material. Such methods yield favorable resolution of the features of the diamond material and enhance reproducibility of the manufacturing process on insulating materials. In addition, examples of methods for transferring the patterned diamond apparatus to an arrangement that provides flexibility for the apparatus, thus forming a flexible patterned diamond apparatus, includes encapsulation, capping, insulating, masking, etching, coating, and releasing the patterned diamond apparatus from the generally rigid substrate.

Patterned diamond apparatus and devices can be manufactured through combinations of processing methods such as, for example, photolithographic techniques, bias enhanced nucleation techniques, and sonication techniques. In one example, the patterned diamond apparatus is manufactured on a generally rigid substrate such that each feature in the diamond pattern is highly-resolved and ranges from 8 micrometers to 500 micrometers in width or length. The apparatus is then released from the rigid substrate and further arranged as a flexible apparatus. In addition, several areas or chips may be arranged on a generally rigid substrate to form multiple patterned diamond apparatuses. In one example, each chip may be approximately 0.25 inches in width and 0.25 inches in length and arranged on a four inch by four inch rigid substrate or wafer.

With reference to FIGS. 1 through 9, an example of a patterned diamond apparatus and methods of manufacturing such an apparatus on a generally rigid substrate are illustrated. As will be further described herein, a photolithographic process may be incorporated into the method of manufacturing a patterned diamond apparatus. As seen in FIG. 1, a substrate or wafer 10 is arranged to provide a structural base for the manufacture of a diamond apparatus. Throughout this disclosure, the term substrate includes, but is not limited to, any component that provides mechanical or structural support whether or not diamond material is deposited, grown, or otherwise coupled to the substrate. For example, the term substrate may refer to a component on which diamond material is directly grown or deposited and may also refer to a component on which diamond material is not directly grown or deposited. As will be understood upon reading and understanding this disclosure, a substrate may be rigid or flexible.

In one example, the substrate 10 is a silicon wafer. As shown in FIG. 1, the silicon wafer 10 is thermally treated so as to form an insulating layer 12 on one surface of the wafer 10. It will be understood by those of ordinary skill in the art that an insulating layer can be formed, deposited, or otherwise coupled on the substrate 10 through a variety of methods. Although the insulating layer 12 may be formed from a variety of insulating materials and in a variety of thicknesses, in one example, the insulting layer 12 is formed from either silicon dioxide or alumina and has a thickness of approximately 1000 angstroms.

After the insulating layer 12 is formed on the wafer 10, a masking material 14 is deposited or otherwise applied to the insulating layer 12 (as shown in FIG. 2). The masking layer 14 may be comprised of materials such as tungsten, copper, molybdenum, silicon carbide, and the like. When tungsten is used for the masking layer 14, the masking layer 14 is generally compatible with an insulating layer 12 formed from silicon dioxide. In addition, a tungsten masking layer 14 is relatively easy to remove from the silicon dioxide insulating layer 12. In one example, the masking layer 14 is deposited by a sputtering method that results in a 1000 angstrom thick layer 14 of tungsten applied to the insulating layer 12.

The masking layer 14 is generally formed and processed to directly affect the arrangement and desired design of the patterned diamond apparatus. In one example, after the masking layer 14 is applied, the masking layer 14 is further processed to form a negative image of the final desired diamond material pattern. In other words, the masking layer 14 is processed to remove the masking material from areas on which it is desired that diamond material be deposited, grown, or otherwise coupled. Masking material is retained in areas on which it is undesirable for diamond material to be deposited, grown, or otherwise coupled.

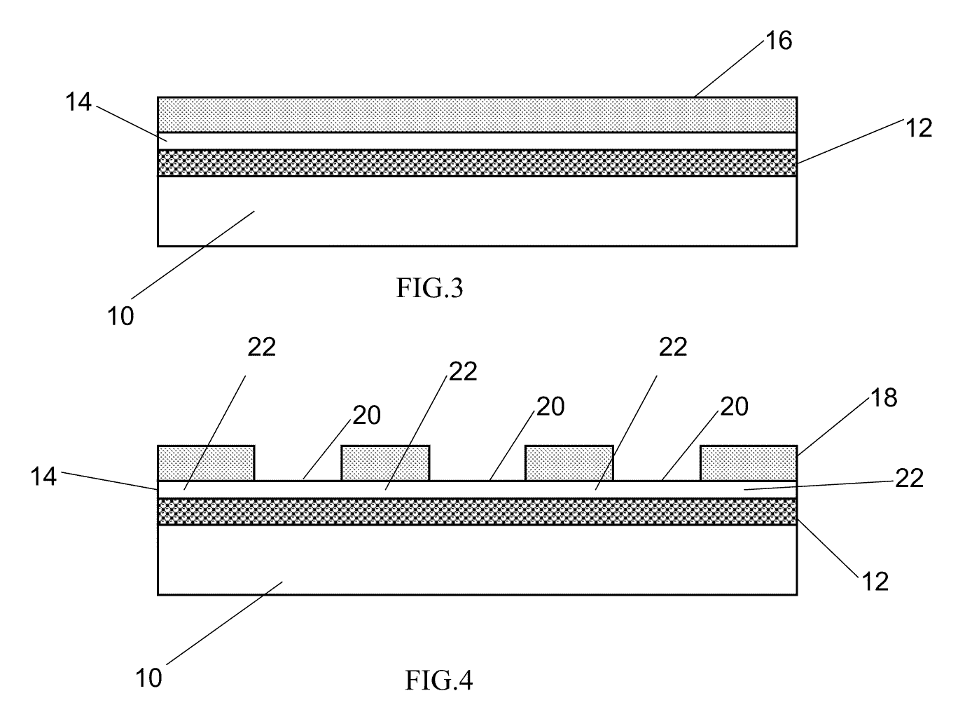

One method of processing the masking material includes the application of a light-sensitive material such as a photoresist onto the masking layer 14. As illustrated in FIG. 3, photoresist material is spin coated to form a photoresist layer 16 on the outer surface of the masking layer 14. Once the photoresist layer 16 is formed, the layer 16 is selectively exposed to UV light transmitted through a photomask designed with a desired pattern. Such a process selectively reacts or cross-links the photoresist layer 16 in a pattern determined by the design of the photomask. It will be readily understood by those of ordinary skill in the art that the pattern of the photomask may be arranged to form any number of patterns that will affect the reaction or cross-linking of the photoresist layer 16.

The un-reacted or non-cross-linked portions of the photoresist layer 16 may be removed using a chemical bath or suitable rinse process. Once the un-reacted portions of the photoresist layer 16 are removed, the remaining photoresist pattern 18 is heated or baked to set the patterned photoresist layer 18. As illustrated in FIG. 4, the removal and heating processes result in patterned photoresist layer 18 that exposes portions 20 of the masking layer 14 and covers or leaves unexposed other portions 22 of the masking layer 14.

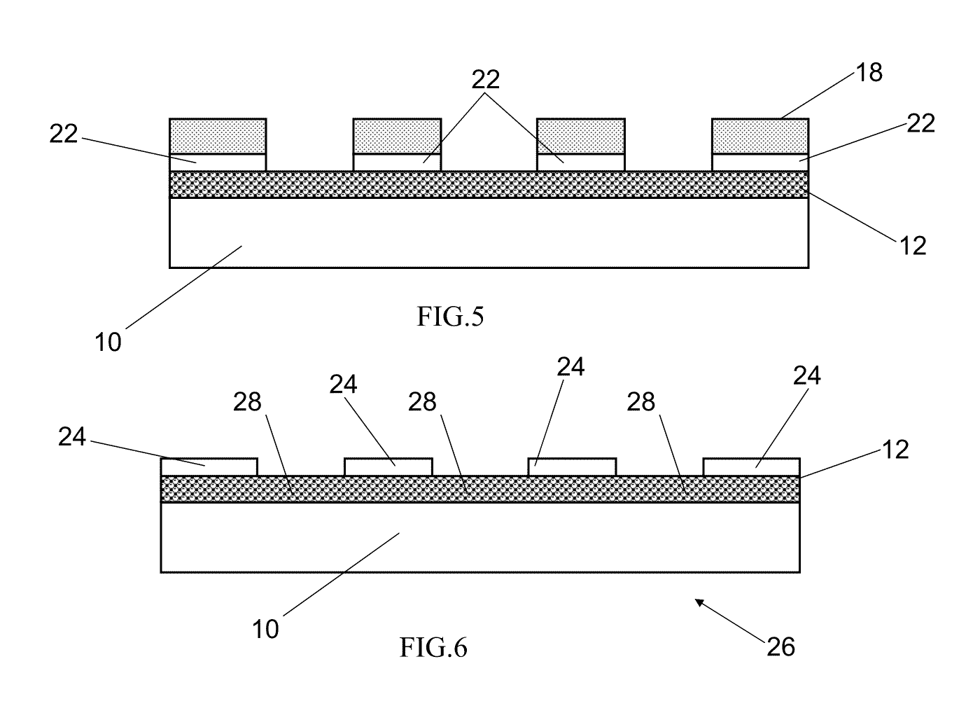

The exposure of portions 20 of masking layer 14 provides access to the exposed portions 20 such that the portions 20 can undergo further processing. For example, the exposed portions 20 of the masking layer 14 can be sonicated in an etchant to remove the exposed portions 20 of the masking layer 14. If the masking layer 14 is comprised of tungsten, an etchant that reacts with or otherwise removes tungsten can be used to remove the exposed portions 20 of the tungsten layer 14. The resulting structure is illustrated in FIG. 5.

Any remaining photoresist material can be removed through additional processing. As seen in FIG. 6, the result is a patterned masking layer 24 rising above the insulating layer 12. The patterned masking layer 24 is arranged as the negative image of the desired final arrangement of the diamond pattern. As will be understood by those skilled in the art upon reading and understanding this disclosure, when diamond material is deposited or grown on the assembly 26 as shown in FIG. 6, diamond material will form a pattern on exposed portions 28 of the insulation layer 12. The desired diamond pattern can be defined by the patterned masking layer 24.

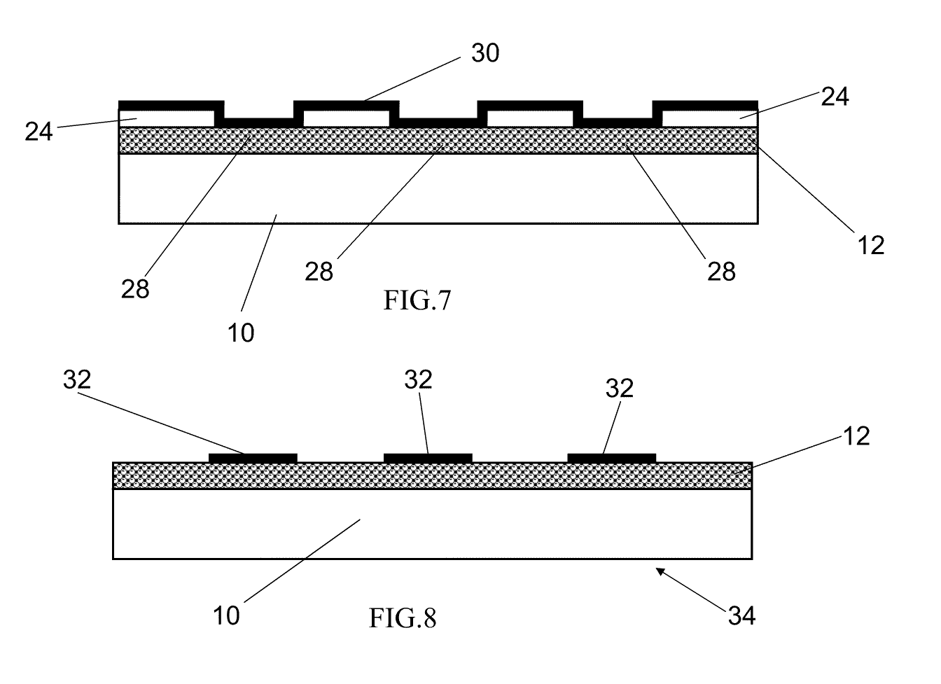

Therefore, the arrangement as seen in FIG. 6 provides a suitable assembly 26 on which to form a diamond apparatus with well-defined features. The diamond apparatus can be manufactured by first seeding or depositing diamond material onto the assembly 26. An initial seeding or deposition step can be accomplished by processes such as biasing enhanced nucleation or sonication in a diamond slurry. Such a step can be considered a pre-growth step. In one example, the result of such processes is a diamond layer 30 grown or deposited on all exposed surfaces, including the patterned masking layer 24 and the exposed portions 28 of the insulating layer 12 (as illustrated in FIG. 7). Once the diamond layer 30 is seeded or grown, the patterned masking layer 24 can be removed using an etchant in an etching solution or other suitable technique. In one example, an etching solution comprises approximately 10 percent hydrogen peroxide and 10 percent sulfuric acid in deionized water. Etching, for example, removes the patterned masking layer 24 and the diamond material seeded or grown on the patterned masking layer 24. The result is a patterned diamond arrangement 32 rising above the insulating layer 12 (as seen in FIG. 8). The resulting patterned diamond arrangement 32 may be the desired diamond pattern. In another example, the resulting patterned diamond arrangement 32 undergoes additional processing to achieve the desired diamond pattern.

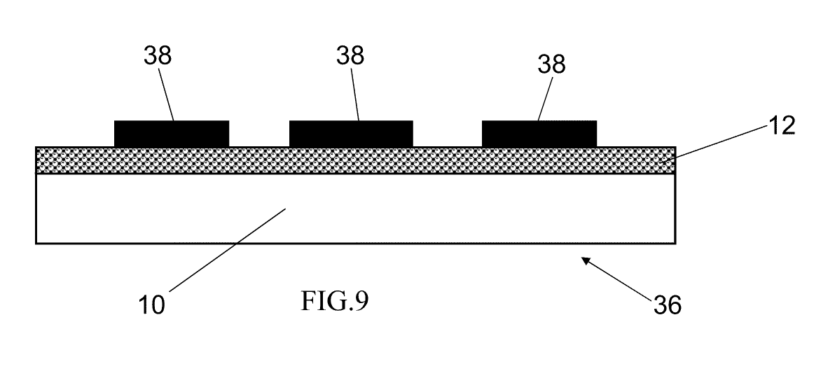

After substantially all the masking material is removed, the resulting assembly 34 is cleaned to remove any remaining loose material or impurities. The patterned diamond arrangement 32 is then optionally subjected to growth treatments to increase the size of the patterned diamond arrangement 32 or individual features of the patterned diamond arrangement 32. As seen in FIG. 9, such growth treatments can result in an assembly 36 with an enhanced patterned diamond arrangement 38 (as seen in FIG. 9). Examples of growth treatment processes include, but are not limited to, microwave plasma chemical vapor deposition (MPCVD) and hot-filament chemical vapor deposition (HFCVD). Such processes can be performed in reactors and other appropriate apparatus.

As previously disclosed, a number of processes can be used to seed or deposit diamond material and/or subsequently grow diamond material to form patterned diamond apparatus. In one example of a sonication seeding method, an assembly with a tungsten masking pattern (such as the assembly 26 shown in FIG. 6) is sonicated in a solution comprising a slurry of approximately 1.0 grams of 0.5 micrometer diamond powder per 100 milliliters of ethanol. The sonication process lasts for approximately 30 minutes, after which the assembly is rinsed in ethanol to remove any excess unseeded diamond powder remaining on the assembly. Once the sonication process is complete, the assembly can optionally be immersed in a tungsten etchant comprising 10 percent hydrogen peroxide and 10 percent sulfuric acid in deionized water to remove the tungsten masking material. After the tungsten is completely or substantially removed, assemblies are again rinsed in ethanol and sonicated for 15 minutes in acetone and 15 minutes in ethanol to clean the surfaces of the assembly. The resulting assembly is similar to the assembly 34 illustrated in FIG. 8. Alternatively, after the sonication seeding process, the assembly may not be subjected to the tungsten etching process. Once the diamond material is seeded, assemblies, both those etched and those alternatively un-etched, can be exposed to HFCVD, MPCVD, or other similar processing for a growth treatment to further grow the patterned diamond arrangement.

For those assemblies that are alternatively un-etched after the sonication seeding process, an etching process can be provided after a growth treatment. A tungsten etchant can be applied either with or without a sonication process. If a sonication process is not used, the assembly can be immersed in an etchant solution and periodically removed from the etchant solution for rinsing in ethanol to remove portions of the diamond-coated tungsten masking material. Once all of the tungsten masking material is removed, the assemblies can be rinsed and sonicated for 15 minutes in acetone and 15 minutes in ethanol. Any growth treatment may be repeated multiple times as necessary to achieve a desired diamond pattern or desired size for the features of a diamond pattern.

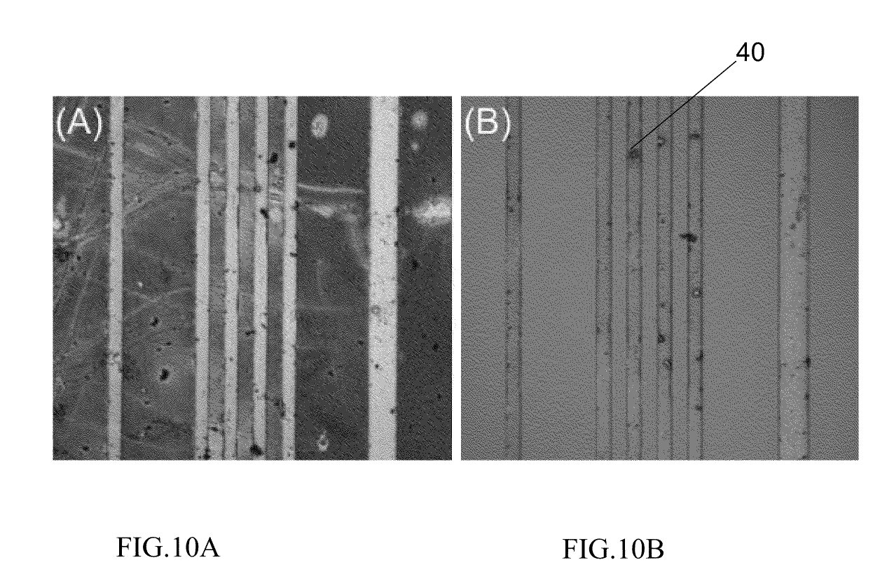

In another example, the seeding method used is bias enhanced nucleation (BEN). An assembly with a tungsten masking pattern, such as the assembly 26 shown in FIG. 6, is sonicated for 15 minutes in acetone and 15 minutes in ethanol. The assembly is then placed in a reactor to undergo MPCVD. The assembly is treated with a bias of approximately 200-300 volts for approximately 30-60 minutes under microwave plasma of approximately 800-1200 watts at a temperature of approximately 700-800 degrees Celsius. After such processing, the assembly is allowed to cool in a hydrogen environment, treated with an etching solution, and cleaned. FIG. 10A is a photograph of an assembly after seeding through BEN at a temperature of 780 degrees Celsius, voltage of 300 volts, current of 350 milliamps, and microwave power of 1000 watts. FIG. 10B is a picture of the same assembly after exposure to an etchant. Diamond features 40 (i.e., the thin vertical strips) are approximately 31 micrometers in width, with the width of the gaps between the diamond features also approximately 31 micrometers. The assembly can then optionally be exposed to MPCVD, HFCVD, or other suitable processes for further growth treatments of the diamond features.

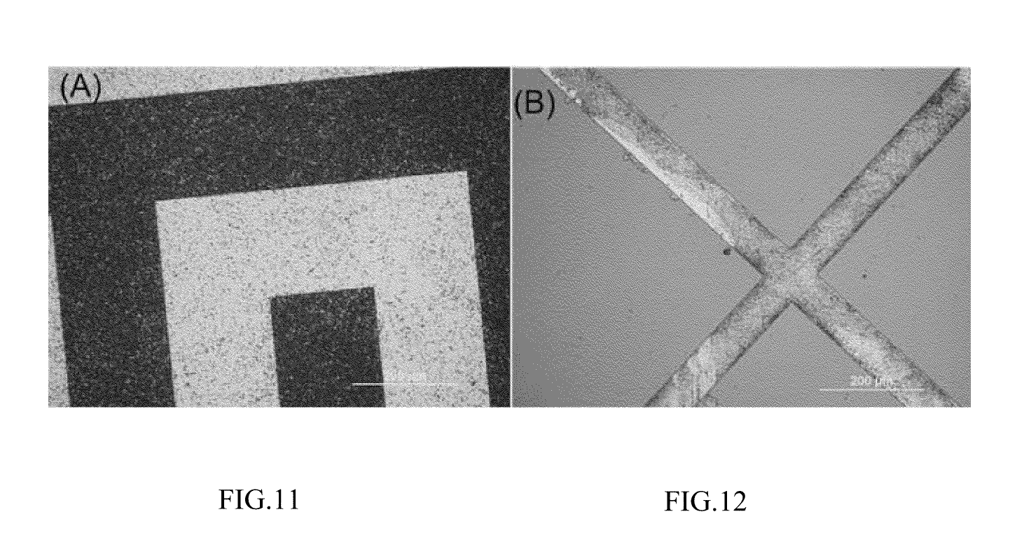

As previously disclosed, HFCVD can be used as a growth treatment to grow or form a diamond pattern. In one example, an assembly is placed in a reactor. The assembly is located on a molybdenum stage at a distance of 7 millimeters from the filaments. The reactor is pumped down, after which the reactor pressure is raised to 20 Torr introducing hydrogen at a flow rate of 196 sccm, methane at a flow rate of 1.8 sccm, and 0.1 percent trimethylboron (TMB) in hydrogen at a flow rate of 4 sccm. The filaments are initially set to a temperature of 2000 degrees Celsius for 30 minutes. This period may be understood to be a nucleation stage. After the nucleation stage, the filament temperature is raised to 2050 degrees Celsius for a two-hour growth stage. FIG. 11 is a photograph of an example of a patterned diamond grown using HFCVD as described above.

MPCVD can also be used as a growth treatment to grow or form a diamond pattern. In one example, an assembly is placed in a reactor for the growth treatment. The assembly is located in the center of the susceptor and held in vacuum for several hours. The reactor is pressurized with hydrogen at a flow rate of 196 sccm, methane at a flow rate of 1.8 sccm, and 0.1 percent TMB in hydrogen at a flow rate of 4 sccm. The resulting pressure in the reactor is approximately 20 Torr. Microwave power is set to 1000 watts forward, and the temperature is brought to 750-800 degrees Celsius through RF heating. A growth treatment lasts approximately 2.5 hours. It will be understood that multiple growth treatments can be applied. After a growth treatment is completed, the microwave plasma is quenched and the RF heater, methane and TMB streams are disengaged, thus, allowing the samples to cool in a hydrogen rich environment. FIG. 12 is a photograph of an example of a patterned diamond growth using MPCVD as described above.

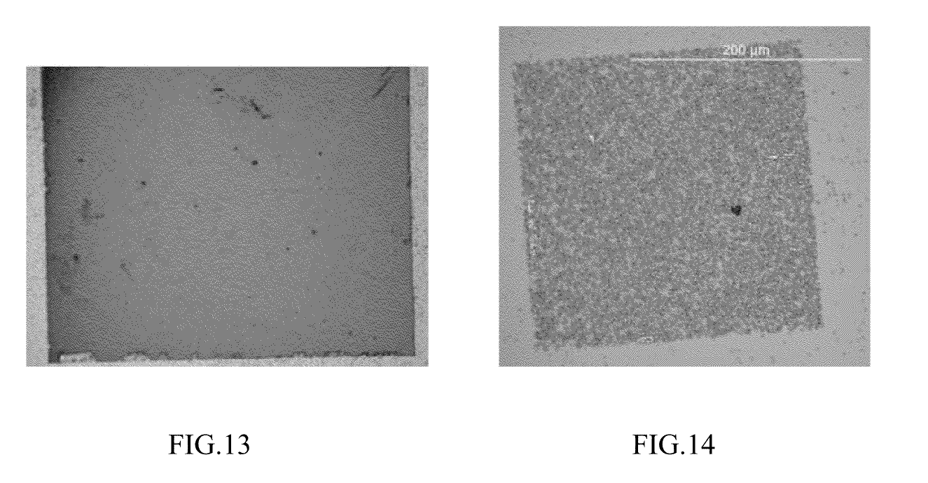

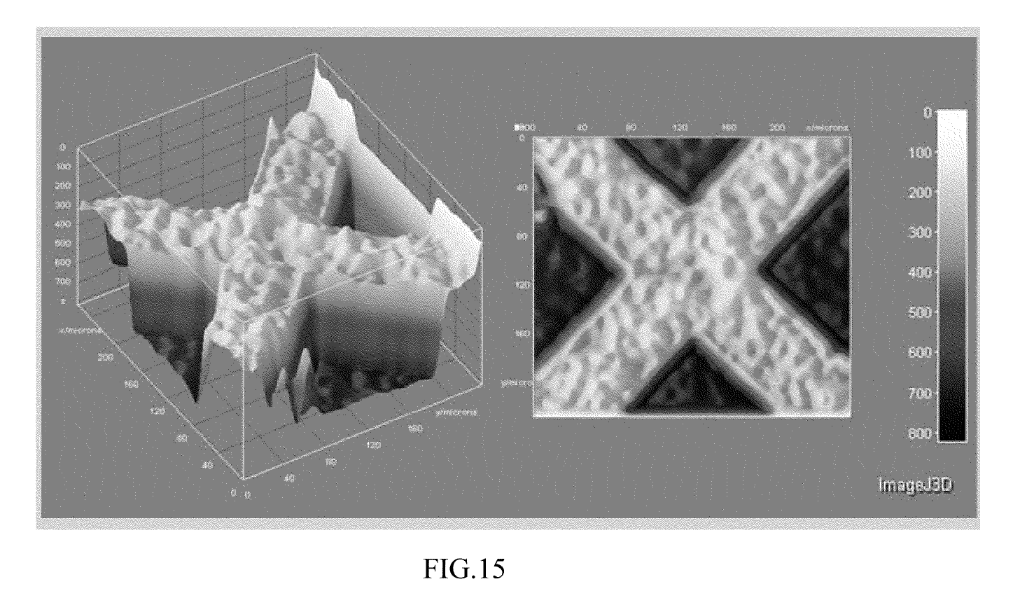

FIG. 13 is a photograph of an example of a patterned diamond growth using bias enhanced nucleation and HFCVD growth. FIG. 14 is a photograph of an example of a patterned diamond growth using sonication and HFCVD growth. FIG. 15 is confocal images of patterned diamond.

Electrical contacts may be applied to the diamond patterns or features of the apparatus for signal propagation from the apparatus. In one example, a three step process is used to form contacts. The first step is to deposit a layer of carbide-forming metal. The layer may be deposited by sputtering. The metal could be for example tungsten, titanium, molybdenum, etc. Such a layer can be deposited as an approximately 200 angstroms thick layer. The second step is to deposit a second layer of a conductive material such as, for example, gold or platinum. The layer may be deposited by sputtering and can be deposited as an approximately 1000 angstrom thick layer. Once deposited the two layers can be annealed at a temperature of approximately 850 degrees Celsius. Annealing of a carbide-forming metal can create a graphitic layer between the electrode contact and the diamond. Such a graphitic layer can lower the Schottky barrier (φB) and specific contact resistance (ρc). If diamond apparatus are formed that have relatively high doping levels or are semi-metallic, the annealing step that forms the carbide layer can be eliminated.

In another example, a contact can be formed through thick-film printing of a single metal layer. The metal selected for the contact can be determined by analyzing the difference in the Fermi levels of the contact material and the patterned diamond material. The Fermi level of diamond material can be dependent on the doping level. The printed metal layer can be, for example, gold or platinum or other such material that have good conductivity and may be suitable for circuitry and implantation in the body.

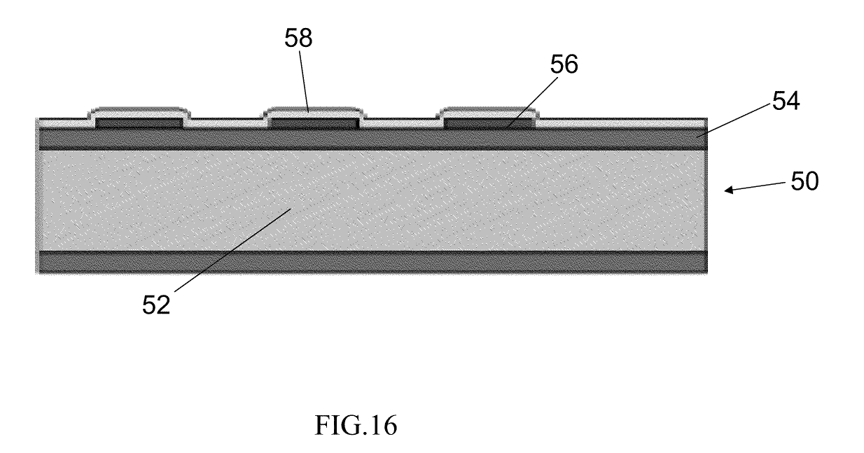

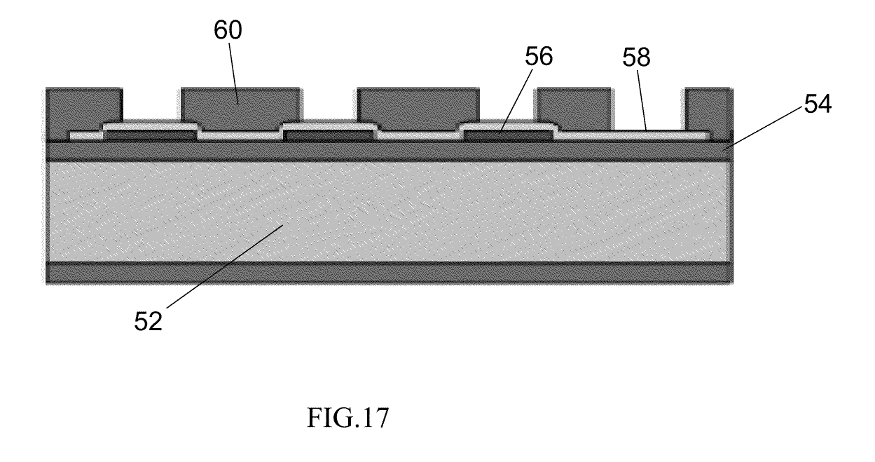

Once a patterned diamond apparatus is formed on a generally rigid substrate, methods and processes can transform the patterned diamond apparatus to a flexible configuration. Such methods include transferring the patterned diamond apparatus to a flexible substrate. With reference to FIGS. 16-25, an example of a flexible patterned diamond apparatus and method for manufacturing such an apparatus are illustrated. As seen in FIG. 16, an example of a method for manufacturing or otherwise forming a flexible patterned diamond apparatus begins with a patterned diamond apparatus 50 formed on a generally rigid substrate 52 similar to the assembly 36 shown in FIG. 9. As described above, an insulating layer 54 is formed on the rigid substrate 52 and a patterned diamond arrangement 56 is deposited or grown on the insulating layer 54. To initiate the flexible diamond apparatus manufacturing method, a polymeric layer 58 is formed on or over the rigid substrate 52, insulating layer 54, and patterned diamond arrangement 56. Such a polymeric layer 58 can be used insulate the diamond arrangement 56 from electrical or thermal communication as will be described below. The polymeric layer 58 can be a capping layer that encapsulates or encloses the patterned diamond arrangement 56 between the capping layer 58 and the insulating layer 54. In one example, a polymer used for the capping layer 58 can be an insulator such as, for example, a polynorbornene (PNB). In other examples, the capping layer 58 can be a parylene, polyimide, or other such material. The capping layer 58 can be applied by casting, spinning, vapor deposition, or other such suitable coating methods. In one example, the capping layer 58 is applies with a spin casting method such that the layer 58 is approximately 1 micrometer in thickness.

The capping layer 58 is processed to form a patterned layer from the capping layer 58. Such patterning can be formed by methods such as photolithography or masking and plasma etching. As seen in FIG. 17, a mask 60 can be applied to the capping layer 58. In one example, the mask 60 is laser-cut kapton tape. In other examples, the mask can be a variety of polymeric materials. The mask 60 can be generally applied or positioned so that the mask 60 is not directly above portions of the diamond material 56. As will be further described, such an arrangement provides for removal of portions of the capping layer 58 that is positioned above portions of the diamond material 56.

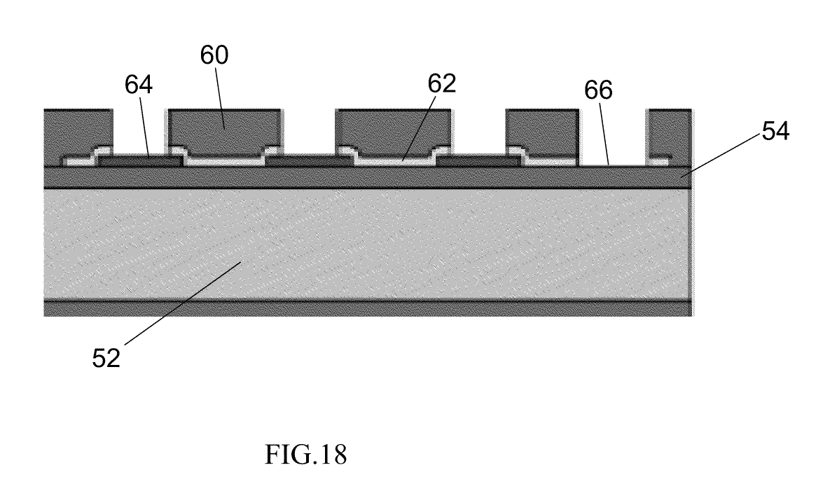

Once the mask 60 is applied, portions of the capping layer 58 that are exposed by the mask 60 can be removed to form a patterned capping layer 62 as seen in FIG. 18. An example of a process for removing the exposed capping layer portions is oxygen plasma etching. Such a process removes the exposed capping layer portions to expose portions 64 of the diamond material and expose portions 66 of the insulating layer 54. Once the etching is completed, the mask 60 is removed to facilitate further processing.

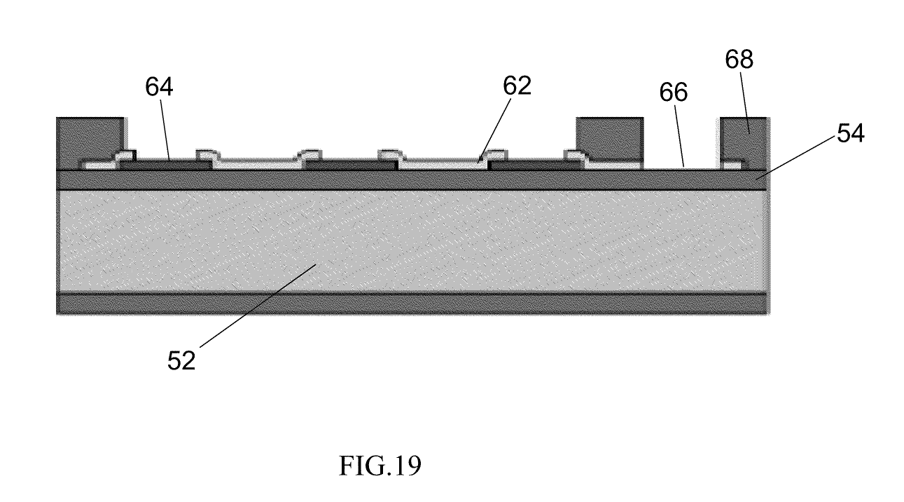

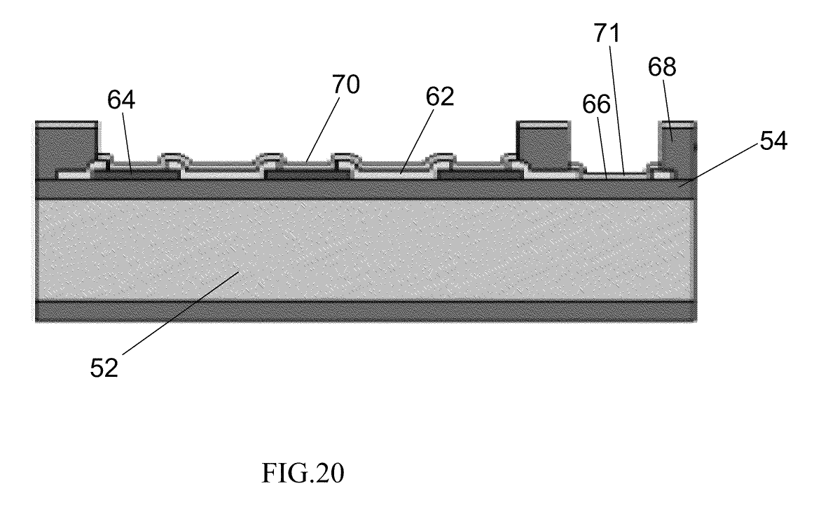

As seen in FIG. 19, a second mask 68 is applied to portions of the patterned capping layer 62. Again, one example of a mask 68 is laser-cut kapton tape, while in other examples the mask 68 can be a variety of polymeric materials. The mask 68 is applied so that portions of the patterned capping layer 62, portions of the diamond material 64, and portions of the insulating layer 66 are exposed. A conductive layer 70 is applied to coat the mask 68, exposed portions of the patterned capping layer 62, exposed portions of the diamond material 64, and exposed portions of the insulating layer 66 (as seen in FIG. 20). In one example, the conductive layer 70 is a 100 nanometer thick layer of gold applied by sputter-depositing. It will be understood by those skilled in the art that any number of conductive materials and any number of application methods for such conductive materials can be used. The conductive layer 70 forms electrical and thermal connectivity between different portions of the diamond material. As will be further discussed, the conductive layer 70 forms an electrical or thermal lead 71 above the formally exposed portion of the insulating substrate 66.

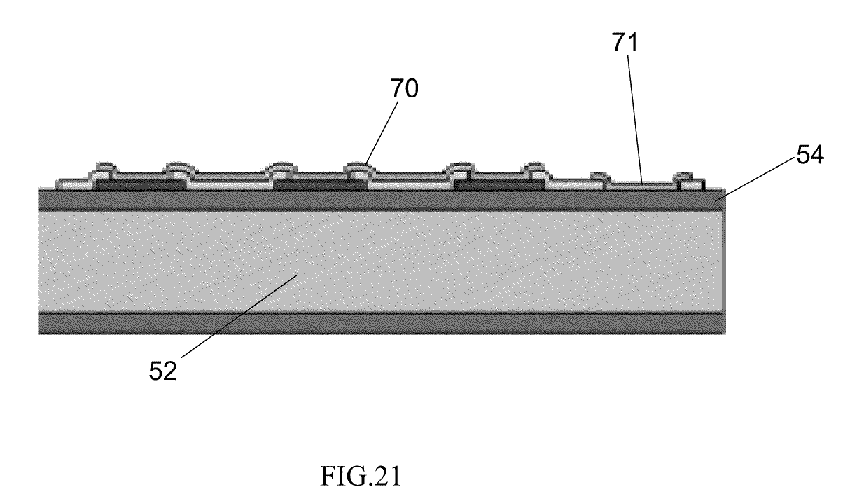

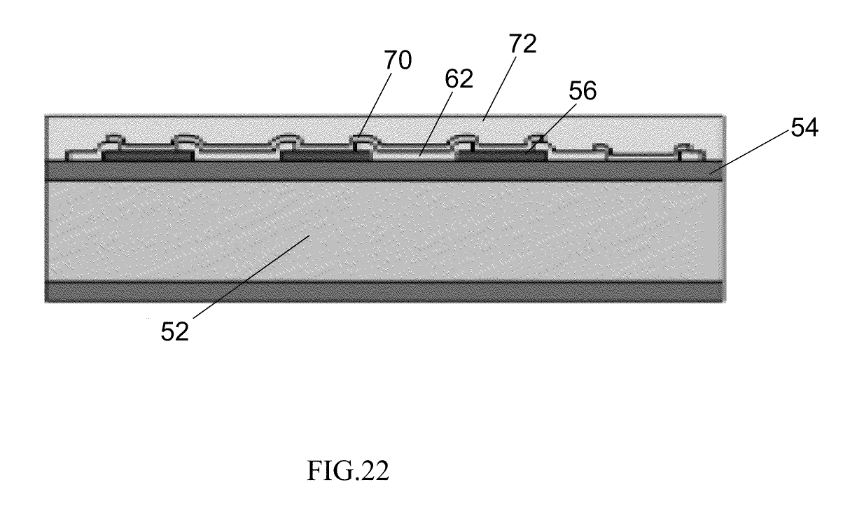

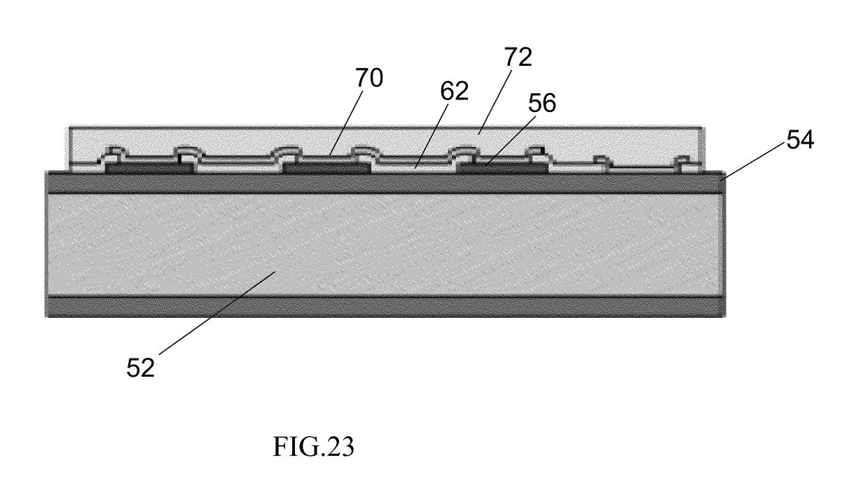

Once the conductive layer 70 is deposited or otherwise formed, the mask 68 is removed as seen in FIG. 21. As seen in FIG. 22, a polymeric layer 72 is formed over the patterned diamond arrangement 56, patterned capping layer 62, and conductive layer 70. As will be further described, the polymeric layer 72 can function as a flexible substrate that provides a patterned diamond apparatus with the ability to flex, twist, bend, and generally deflect. In one example, the polymer used for the flexible substrate 72 is PNB. The flexible substrate 72 can be applied by casting, spinning, vapor deposition, or other such suitable methods. In one example, the flexible substrate 72 is applies with a spinning method such that the flexible substrate 72 is approximately 50 micrometer in thickness. As seen in FIG. 23, the flexible substrate 72 and the capping layer 62 can be trimmed or cut to the desired size of the final flexible patterned diamond apparatus. In one example, the flexible substrate 72 and capping layer 62 is cut by a laser cutting process.

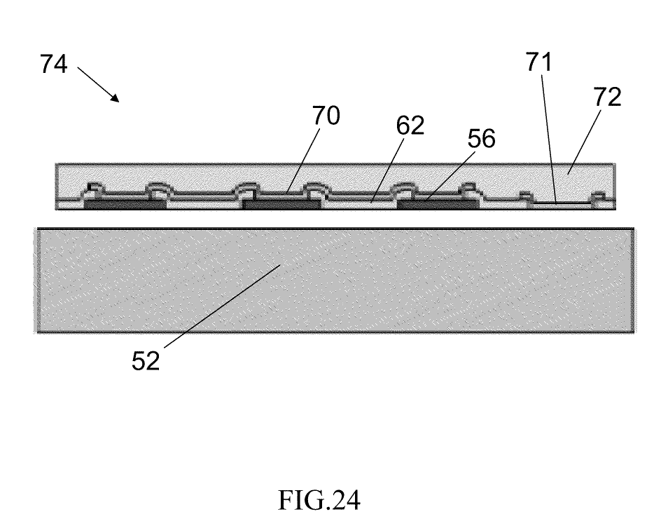

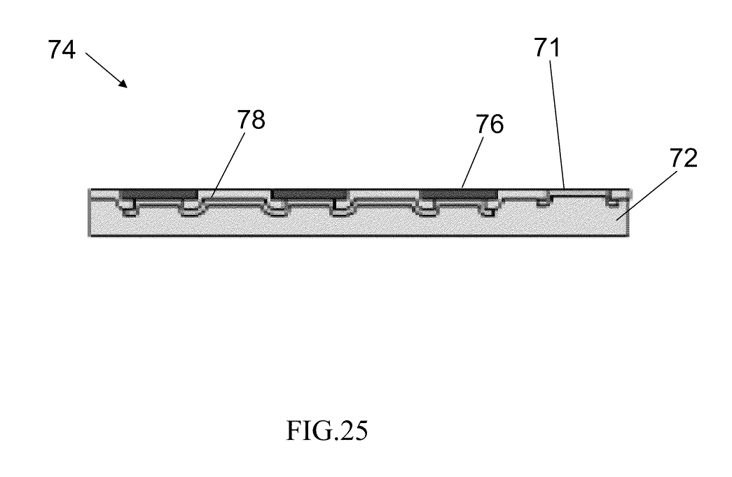

Once the flexible substrate 72 is applied and cut, a release or transfer process is used to form a flexible patterned diamond apparatus 74. As seen in FIG. 24, one method of releasing is to dissolve the insulating layer 54 to free the flexible patterned diamond apparatus 74 from the generally rigid substrate 52. In one example, the insulating layer 54 is dissolved in 49 percent hydrofluoric acid. As shown in FIG. 25, the resulting flexible patterned diamond apparatus 74 includes multiple diamond features or electrodes 76 interconnected by conductive linkages 78 with a lead 71 so that other devices can be connected to the flexible patterned diamond apparatus 74. As it will be understood, the surface of an electrode 76 is the surfaces that were formally coupled to the insulating layer 54 before the dissolving of the insulating layer 54. As will also be understood, although not shown in the figures, the lead 71 is in electrical or thermal communication with the electrodes 76 because of the two dimension nature of the conductive linkages 78.

In examples of flexible patterned diamond apparatus and methods of forming such apparatus the following steps, techniques, materials, or methods can be incorporated. The material used for the capping layer can be arranged to be generally resistant to hydrofluoric acid. The deposition of the conductive layer can be accomplished by patterning a negative tone photoresist before deposition of the metal such that when photoresist is dissolved in an organic solvent, only the desired metal remains.

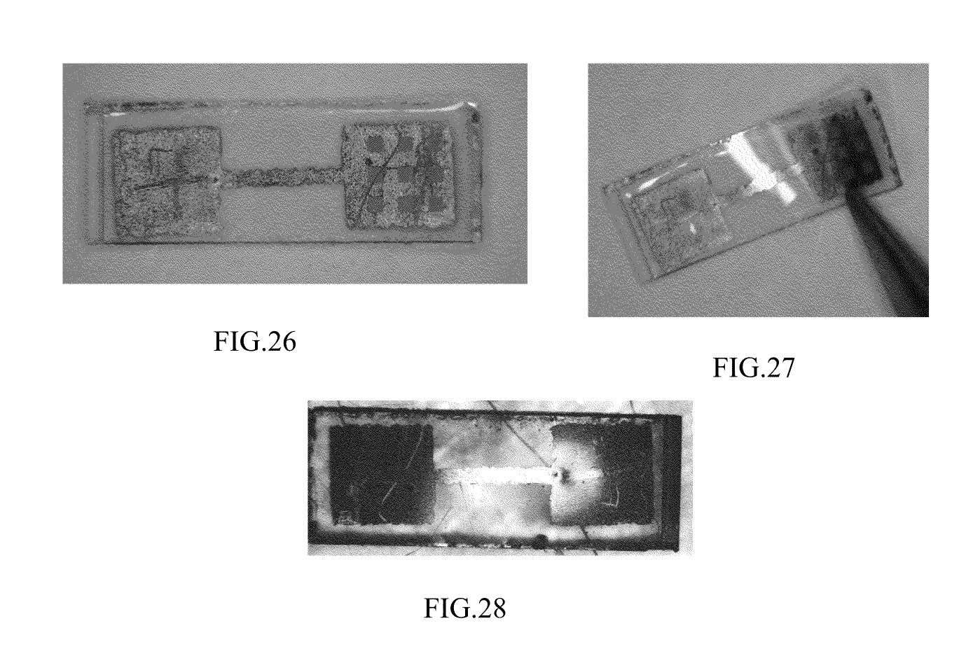

Flexible patterned diamond apparatus as disclosed herein can be applied in electrochemical applications. The flexible patterned diamond apparatus can be arranged as a thin film and exhibit conductive properties with a side potential window, low baseline current, and chemical robustness. FIGS. 26 through 28 are photographs of flexible patterned diamond apparatus. The flexible patterned diamond apparatus include segmented diamond electrodes, where each electrode is approximately 250 micrometers by 250 micrometers. The conductive layer is a 100 nanometer thick palladium layer. The flexible substrate is a 50 micrometer thick layer of polynorbornene.

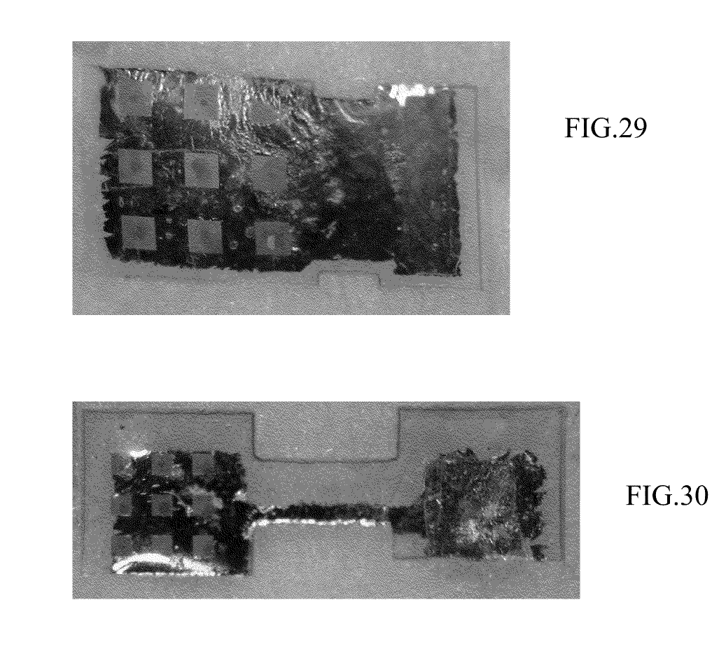

FIG. 29 is a photograph of a 500 micrometer by 500 micrometer diamond electrodes with a 100 nanometer nm thick gold conductive layer, a 50 micrometer thick polynorbornene flexible substrate layer, and a 1 micrometer thick PNB capping layer. FIG. 30 is a photograph of 250 micrometer by 250 micrometer diamond electrodes, with a 100 nanometer nm thick gold conductive layer, a 50 micrometer thick polynorbornene flexible substrate layer, and a 1 micrometer thick PNB capping layer.

In other examples, apparatuses and methods disclosed and described herein are generally directed to growing, coating, layering, depositing, or otherwise coupling diamond material to a relatively high-temperature substrate such that at least portions of the substrate remain ductile after the diamond material is coupled to the substrate. Apparatuses and devices can be formed or otherwise manufactured by coupling diamond material to a substrate. Throughout this disclosure the term “coating” will generally be used to describe coupling diamond material to a substrate. The term “coating” is not to be read as limiting. Coating includes a variety of coupling methods such as, but not limited to, deposition, growing, layering, and the like.

The coating of a substrate typically occurs in a generally harsh environment. For example, elevated temperatures in the range of 800 to 1000 degrees Celsius are often required to grow diamond on a substrate. Substrates that can withstand such temperature ranges are, for example, tungsten, molybdenum, silicon, and titanium. However, when an apparatus is formed by coating diamond on such substrates, formation of a brittle carbide layer during coating can limit the applications suitable for the apparatus. Such brittle layers can fracture or otherwise break when stress is applied to the apparatus. For example, if a brittle layer is formed during the manufacture of an apparatus on a substrate, the apparatus may fail when subjected to bending, flexing, twisting, or similar deformations. Apparatuses and devices formed from coating a substrate with diamond material can benefit from the substrate remaining ductile after the formation of the apparatus. As will be disclosed herein, the selection of materials and diamond growth conditions can improve the ductility of an underlying substrate after diamond growth.

As will be appreciated, diamond is a well-suited material for electronics where degradation or corrosion is a concern. Diamond material is generally a corrosion-resistant material. The conductivity of diamond ranges from insulating to semi-metallic, where the conductivity can be systematically varied by doping. Therefore, diamond material can be formed and/or doped to suit a custom application. Examples of applications for diamond apparatus include, but are not limited to, biomedical devices, corrosion-resistant insulating coatings, semiconductors, and electronic components.

A generally ductile diamond film electrode can be arranged as an implantable biomedical device. Such a film device can be implanted in a person or animal such that the person or animal can move freely and does not have to modify its behavior because of the implantable biomedical device. A generally ductile diamond wire electrode can also be arranged as an implantable biomedical device. A portion of the wire substrate can be coated with diamond and an uncoated portion of the substrate can serve as an electrical lead. Such a wire device may also be implanted in a person or animal such that the person or animal can move freely and does not have to modify its behavior due to the implantable biomedical device. This is to say that the a diamond electrode can be formed or manufactured such that it remains generally ductile or flexible so that the stresses seen by the electrode due to the normal movements of a person or animal does not cause the electrode to cease functioning.

In one example, a diamond electrode implantable biomedical device can be implanted to electrochemically record neurotransmitter concentrations and record and stimulate electrical activity in neurons. In another example, such neurotransmitter concentrations can be recorded at levels as low as 1 nM. In yet another example, a diamond implantable biomedical device allows for real-time feedback.

Alloys can be used as substrates for diamond devices. For example, molybdenum-rhenium, tungsten-rhenium, as well as other rhenium alloys can be used as substrates. Generally, rhenium alloys do not form a brittle carbide layer during the coating of diamond material onto the substrate. In an example, diamond films grown on rhenium alloy wire substrates do not easily delaminate, and the wire substrate does not fracture or otherwise break as typical stresses are applied to the substrate. Thus, the wire substrate remains ductile or otherwise flexible after the application of diamond to the substrate.

Examples of substrates that can retain substantial ductility after diamond coating include metal wire or metal foil. Diamond material coated on such substrates can be arranged as electrodes for biological applications. In one example, such an electrode can be arranged as an in vivo electrode that is, for example, positioned proximate to a nerve in a live body for passive chronic recording of electrical activity. Because of the biocompatibility and resistance to corrosion of diamond material, diamond electrodes can perform for relatively long periods of time in an in vivo environment.

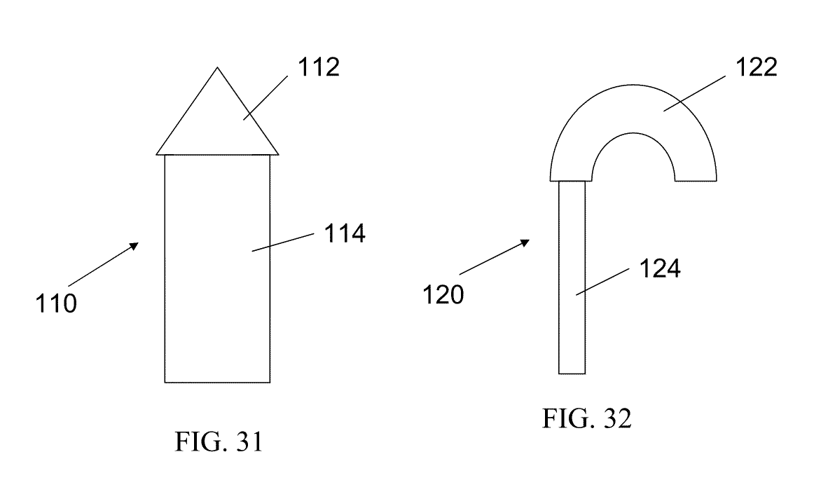

As shown schematically in FIG. 31, one example of a diamond electrode 110 includes a cone-shaped portion 112 of diamond material grown onto a wire substrate 114. One use for such a cone-shaped diamond electrode 110 is for insertion of the electrode 110 into the brain for studying the brain and sensing chemicals in the brain. As schematically shown in FIG. 32, another example of a diamond electrode 120 includes a hook-shaped portion 122 of diamond material grown onto a pre-bent wire substrate 124. One use of such a hook-shaped diamond electrode 120 is for insertion into the body for studying or stimulating nerves and ganglia. Diamond electrodes 110, 120 can be formed by growing or otherwise depositing diamond material onto substrates comprised of rhenium alloys such as, for example, molybdenum-rhenium and tungsten-rhenium alloys.

Diamond apparatuses provide for good in vivo sensors because of the corrosion resistance and biocompatibility of diamond material. Such sensors can be arranged as a planar electrode. Planar electrodes can be manufactured by growing diamond onto a film. The diamond can be grown so that arrays of diamond are formed in a variety of complex planar geometries. In vivo sensors can also be arranged as non-planar electrodes by growing diamond on a wire substrate. Such non-planar electrodes can be arranged to penetrate tissue without unnecessarily damage to surrounding tissue. Such electrodes can also be generally positioned precisely and can be suitable for three-dimensional environments.

As previously described, alloying rhenium with metals such as tungsten or molybdenum can result in substrates for the growth of diamond electrodes. Such substrate materials yield a flexible sensor or electrode where the diamond material has good adhesion to the substrate. In one example, an alloy substrate comprises approximately 75 percent tungsten and 25 percent rhenium by volume. In another example, an alloy comprises approximately 52.5 percent molybdenum and 47.5 percent rhenium by volume.

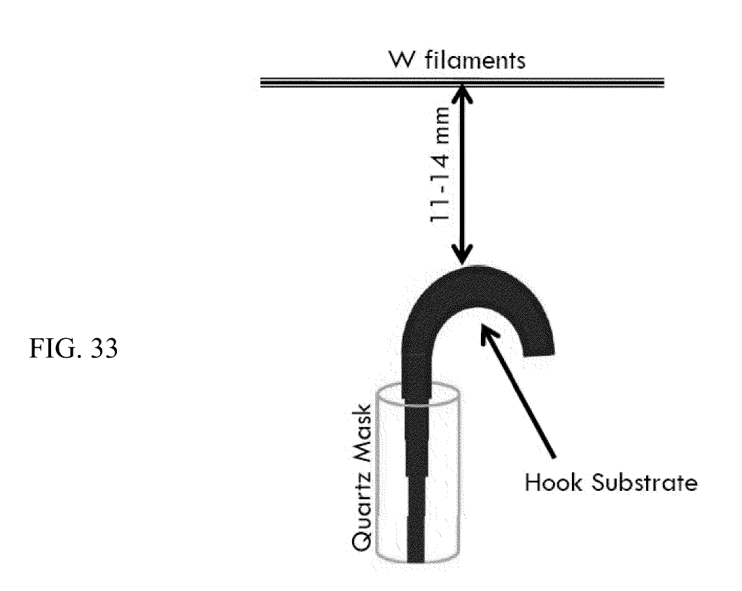

An example of a diamond growth method is illustrated in FIG. 33. The method illustrated is hot filament chemical vapor deposition. A wire substrate is pre-shaped so that one end has a generally curved or hooked shape. The substrate is placed in a reactor or other suitable chamber so that the substrate is approximately 11 to 14 millimeters from a tungsten filament. The tungsten filament is heated to approximately 2050 degrees Celsius, and the substrate temperature is approximately 800 to 900 degrees Celsius. The pressure in the reactor is approximately 20 torr. A quartz capillary is used to mask growth from a portion of the substrate and to provide support for the substrate. The environment is pressurized with a 0.9 percent methane stream feed—196 sccm hydrogen, 4.0 sccm trimethyl boron (1000 ppm in hydrogen), and 1.8 sccm methane. This duration of the growth stage can be set to achieve the desired thickness and crystal size for the diamond coating. In addition, parameters such as temperature gas composition, etc. can be selected to achieve desired properties.

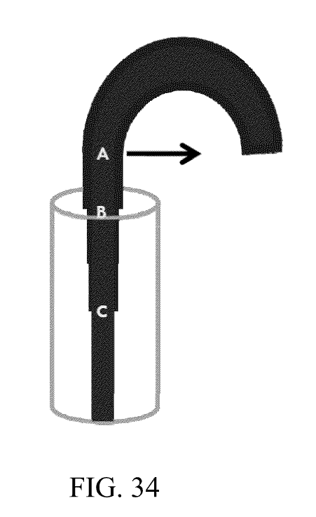

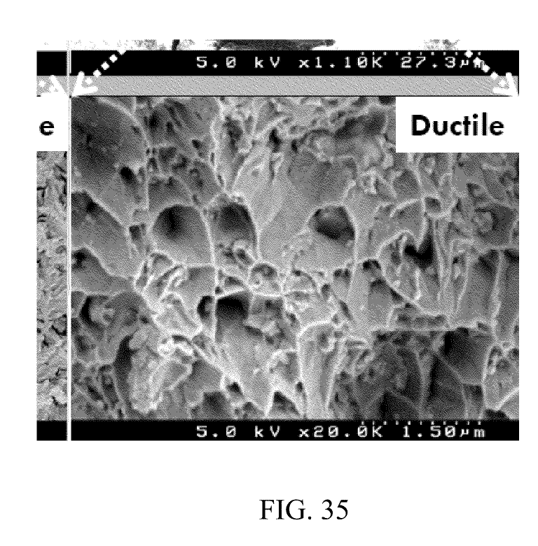

FIG. 34 schematically illustrates a diamond hook-shaped apparatus resulting from the method shown in FIG. 33. Section A is a diamond coated portion with a curved section and a straight section above the quartz capillary. Section B is at the edge of the quartz mask, where a significant drop off in diamond thickness is seen. Section C is a diamond growth boundary. Such a method results in a ductile diamond apparatus. The ductile nature of the apparatus is seen in the highly magnified picture of a fracture surface of the substrate shown in FIG. 35.

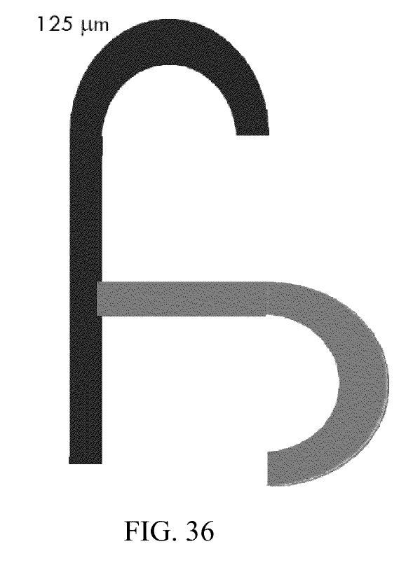

Experimentation has shown that when a molybdenum-rhenium alloy substrate is used to grow diamond in a hydrogen environment, the substrate can be deflected approximately ninety degrees before the substrate fractures (as shown in FIG. 36). Experimentation has also shown that molybdenum-rhenium alloy substrates are generally not affected by the duration of the diamond growth stage.

Additional experimentation has shown that a tungsten-rhenium alloy may be generally affected by the duration of the diamond growth stage. When diamond is grown for four hours in a hydrogen environment, the substrate can be deflected approximately seventy-five degrees before the substrate fractures. When diamond is grown for twenty hours in a hydrogen environment, the substrate can be deflected approximately thirty degrees before the substrate fractures. When a tungsten substrate is used, the substrate typically fractures at about thirty degrees of deflection.

The following description is directed to general testing of various alloys. As previously described, an in vivo diamond electrode or device can be fabricated with a flexible substrate. In the development of diamond devices, two metal alloys, 52.5% molybdenum/47.5% rhenium (by volume) and 75% tungsten/25% rhenium (by volume), can be used as substrates for diamond growth. Scanning electron microscopy (SEM), microRaman (Raman) spectroscopy, and slow scan cyclic voltammetry (SCV) can be used to evaluate the quality of diamond film grown on such substrates. After diamond growth, the bend-to-fracture rotation of the substrates in uncoated portions can be compared to tungsten, which can serve as a baseline material. The flexibility can be evaluated by investigating cross sectional images of samples. Diamond hook electrodes made in this fashion can be tested in vitro to evaluate capability for electrical recording.

Testing of Rhenium alloys as substrates for diamond electrodes or devices remained flexible after diamond growth while having strong diamond film adhesion. Rhenium, an effective substrate for flexibility after growth of the diamond material, can be combined with other metals to achieve an effective substrate for bond strength (adhesion) to the diamond film. During testing, three rhenium alloys were examined: 52.5% molybdenum/47.59% rhenium (by volume) (Mo/Re), 75% tungsten/25% rhenium (by volume) (W/Re), and 97% tungsten/3% rhenium (by volume) (W/3Re).

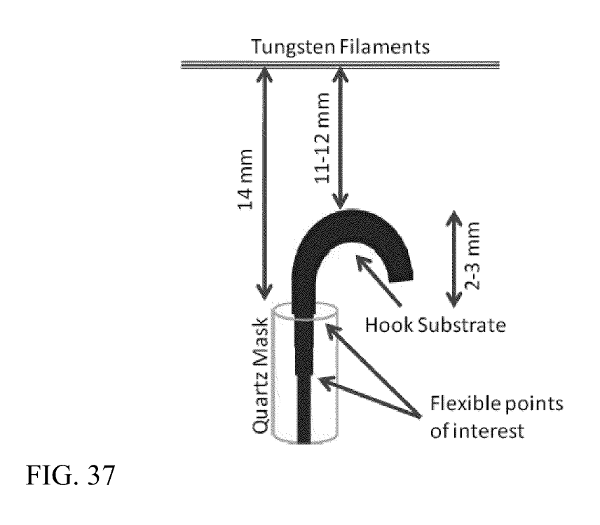

During testing, substrates were manually shaped into hooks and seeded for diamond growth by sonication in a diamond slurry. The hook-shape was chosen because of the animal model studied. One of ordinary skill in the art will understand that diamond electrodes an be any of a number of shapes including for example straight wire, bent wire, patterned sheets, and un-patterned sheets. A slurry was prepared by adding 0.3 g of 8 nm diameter diamond powder to 90 mL of ethanol. The substrates were suspended in the slurry for a 45 min. sonication and then cleaned with a 15 minute sonication in 200 proof ethanol. A straight wire section of the substrate was threaded into a quartz capillary mask to provide mechanical support and limit growth to the desired hook area, see FIG. 37. Each hook-shaped wire protruded 2-3 mm from the end of the capillary, and the tip of the hook positioned 11-12 mm from the hot filaments during diamond growth. The total distance from the filaments to the closest edge of the capillary mask was 14 mm. No heat sink was used in this growth process. Diamond was deposited in a hot-filament chemical vapor deposition reactor at 20±0.1 torr, 0.9% CH₄ and 40 ppm in H₂, and a filament temperature of 2000±10° C. The growth time was varied to investigate effect on flexibility and quality.

Diamond material was grown on a 150 μm diameter Mo/Re wire at the previously described growth conditions (growth condition 1). Uncoated regions of the resulting diamond device remained flexible after diamond growth. In a another test, the growth conditions were changed by placing the substrate 3 mm closer to the filaments (growth condition 2). The shorter substrate-to-filament distance produced high quality diamond material.

The flexibility of the underlying Mo/Re substrate in the diamond coated region was qualitatively investigated by bending the wires by hand. This process tested the ductility of the underlying substrate and the adhesion of the diamond film to the substrate. The substrate bent over 90°. The diamond film did not delaminate. No cracks were observed in the underlying Mo/Re substrate.

At normal growth conditions, diamond films were successfully grown for various growth times on Mo/Re, W/Re, W/3Re, and W (tungsten). W, a traditional substrate for diamond growth, was a control. The flexibility of each substrate was initially assessed by qualitative measurements. Mo/Re was the most flexible, being able to withstand many bending movements over 90°. W/Re was slightly less flexible, breaking slightly after some movement, but not completely fracturing until more force was introduced. W was inflexible, but able to be handled gently.

These diamond electrodes were analyzed by SEM, Raman spectroscopy, SCV, and bend-to-fracture testing with fracture images. In addition to the previously described analysis techniques (SEM, Raman spectroscopy, and SCV), bend-to-fracture testing analysis and fracture images were obtained to determine the maximum bend rotation as a measure of flexibility of the uncoated substrate after diamond growth.

The diamond films were grown at growth condition 1 on Mo/Re and W/Re, and they were compared to a diamond grown on W at the same growth conditions. A 125 μm diameter wire was used for much of the analysis, with exception that a 50 μm diameter wire was used for filament age and fracture images. Samples with 4 hr, 8 hr, and 20 hr growth times were used for analysis with a 30 min nucleation stage for each growth. In addition, an H₂-only environment control run, for 4 hrs at growth temperatures, was conducted for each substrate. The variables that were focused on when evaluating the film quality and substrate flexibility were the growth time, substrate, and filament age.

The diamond growth was equivalent on all three substrates, Mo/Re, W/Re, and W. The film quality increased as the growth time increased and the filament age increased. A 4 hr diamond growth was found to have limited electrochemical activity in these particular tests. A 20 hr growth showed results with a large potential window and small baseline current. Dopamine was also detected from a diamond film grown for 20 hrs on all three substrates, and the signal was stable.

The diamond film was similar on all three substrates, Mo/Re, W/Re, and W. The mechanical properties differed between the three substrates as observed through bend rotation testing. Mo/Re was found to be the most flexible. W was found to be the least flexible. Diamond film deposited for 20 hrs on a Mo/Re substrate was found to be flexible and have the highest quality film in the qualification tests. The sample had large crystal sizes, little sp² content, good electrochemical activity, and good bend rotation. Testing showed that the Mo/Re substrate became more flexible when the diamond films were grown further from the filaments.

Diamond devices were tested in vitro. Diamond was grown on two pre-bent Mo/Re wires for 20 hrs to hook them on the nerve, BN2, in vitro in to verify the capability for detecting electrical neural activity. The two wires, one to hook the nerve and one for electrical ground, were insulated with nail polish and twisted together to reduce noise. A buccal ganglion was isolated and pinned out, and the diamond electrode was attached to BN2 using superglue. Diamond recorded several action potentials generated by spontaneous activity at 0 hrs and 31 hrs. Electrical activity was obtained for 31 hrs before the ganglion died. A complete diamond film with no delamination was observed. This test also confirmed generally strong adhesion between the diamond film and the underlying substrate.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art.

What is claimed is:

1. A method of manufacturing a patterned diamond apparatus including:
forming an insulating layer on a surface of a first substrate;
forming a masking layer on a surface of the insulating layer;
forming a photoresist layer on a surface of the masking layer;
exposing a first portion of the photoresist layer to light to cross-link the first portion of the photoresist layer and leaving a second portion of the photoresist layer non-cross-linked;
removing the second portion of the photoresist layer to exposing a first portion of the masking layer;
removing the first portion of the masking layer to expose a first portion of the insulation layer;
removing the first portion of the photoresist layer to form a patterned masking layer extending from the insulation layer;
seeding diamond material onto the patterned masking layer and the first portion of the insulation layer; and
removing the patterned masking layer to form a patterned diamond apparatus extending from the insulating layer.

2. The method of claim 1 further including:
transferring the patterned diamond apparatus from the insulation layer to a second substrate.

3. The method of claim 2, where the second substrate is flexible.

4. The method of claim 1 further including:
forming a second substrate about the patterned diamond apparatus; and
removing the second substrate and the patterned diamond apparatus from the first substrate.

5. The method of claim 4, where the second substrate is flexible.

6. A patterned diamond apparatus including:
a substrate;
an insulation layer coupled to a surface of the substrate;
a first feature coupled to a surface of the insulation layer and arranged in a first pattern; and
a second feature coupled to the surface of the insulation layer and arranged in a second pattern.

7. A flexible patterned diamond apparatus including:
a flexible substrate;
a network of connections secured to the flexible substrate, and
a patterned diamond portion secured to the flexible substrate and in electrical or thermal communication with the network of connections.
